(19) United States
(12) Patent Application Publication
(10) Pub. No.: US 2024/0394017 A1
(43) Pub. Date: Nov. 28, 2024

(54) MASKING-BASED DIGITAL BINARY MULTIPLIER

(71) Applicant: Microsoft Technology Licensing, LLC, Redmond, WA (US)

(72) Inventor: Mathew Kent HALL, Redmond, WA (US)

(21) Appl. No.: 18/321,639

(22) Filed: May 22, 2023

(51) Int. Cl. G06F 7/523; G06F 7/50; G06F 7/544

(52) U.S. Cl. CPC G06F 7/523; G06F 7/50; G06F 7/5443

(57) ABSTRACT

Embodiments of the present disclosure include systems and methods for providing masking-based digital binary multipliers. A digital binary multiplier may receive a first plurality of input bits and a second plurality of input bits. The digital binary multiplier may receive a control signal indicating a mode of operation in a plurality of modes of operation. The digital binary multiplier may generate a plurality of partial products based on the first plurality of input bits and the second plurality of input bits. The digital binary multiplier may, based on the control signal, mask a subset of the plurality of partial products. The digital binary multiplier may generate a plurality of output bits based on the plurality of partial products.

### BACKGROUND

The present disclosure relates to computing hardware. More particularly, the present disclosure relates to digital binary multipliers.

A digital binary multiplier is a hardware component that is typically configured to perform multiplication operations. For instance, a digital binary multiplier may be configured to take two binary inputs that represent two values, perform bit multiplication on the two binary inputs, and generate a binary output that represents the product of the two values. Digital binary multipliers are utilized in many applications including central processing units (CPUs), mobile computing devices, hardware accelerators, etc.

### BRIEF DESCRIPTION OF THE DRAWINGS

Various embodiments of the present disclosure are illustrated by way of example and not limitation in the figures of the accompanying drawings.

FIG. 1 illustrates a masking-based digital binary multiplier according to some embodiments.

FIG. 2 illustrates a first mode of operation for the masking-based digital binary multiplier illustrated in FIG. 1 according to some embodiments.

FIG. 3 illustrates a second mode of operation for the masking-based digital binary multiplier illustrated in FIG. 1 according to some embodiments.

FIG. 4 illustrates a third mode of operation for the masking-based digital binary multiplier illustrated in FIG. 1 according to some embodiments.

FIG. 5 illustrates a fourth mode of operation for the masking-based digital binary multiplier illustrated in FIG. 1 according to some embodiments.

FIG. 6 illustrates a process for performing masking-based bitwise multiplication according to some embodiments.

FIG. 7 illustrates an artificial intelligence (AI) accelerator according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for providing masking-based digital binary multipliers. In some embodiments, a digital binary multiplier is configured to receive two sets of input bits that represent two input values. The digital binary multiplier performs logical AND operations between each bit in the first input with each bit in the second input. The ANDed values are referred to as partial products. The digital binary multiplier is also configured to receive a control signal that indicates one of several modes of operation of the digital binary multiplier. Each mode of operation of the digital binary multiplier configures the digital binary multiplier to perform multiplication on inputs having a particular bit-length. Based on the control signal, the digital binary multiplier masks a portion of the partial products. Finally, the digital binary multiplier sums the partial product to generate a set of output bits that represents the product of the two input values.

The techniques described in the present application provide a number of benefits and advantages over conventional methods for providing digital binary multipliers. First, the masking approach can lower dynamic power consumption by reducing activity in unused multiplier circuits due to the fact that their inputs are masked instead of simply computing all potentially needed outputs and selecting the ones that are actually needed for a given mode. Second, such an approach can also make it easier to route designs on advanced process nodes by adding pins to partial product generators and summation circuits, which have relatively lower pin density than multiplexers. Third, providing a digital binary multiplier with different modes of operations in multiplication can be performed on inputs having different bit-lengths allows a single digital binary multiplier to flexibly perform higher precision multiplications at lower throughput and lower precision multiplications at higher throughput.

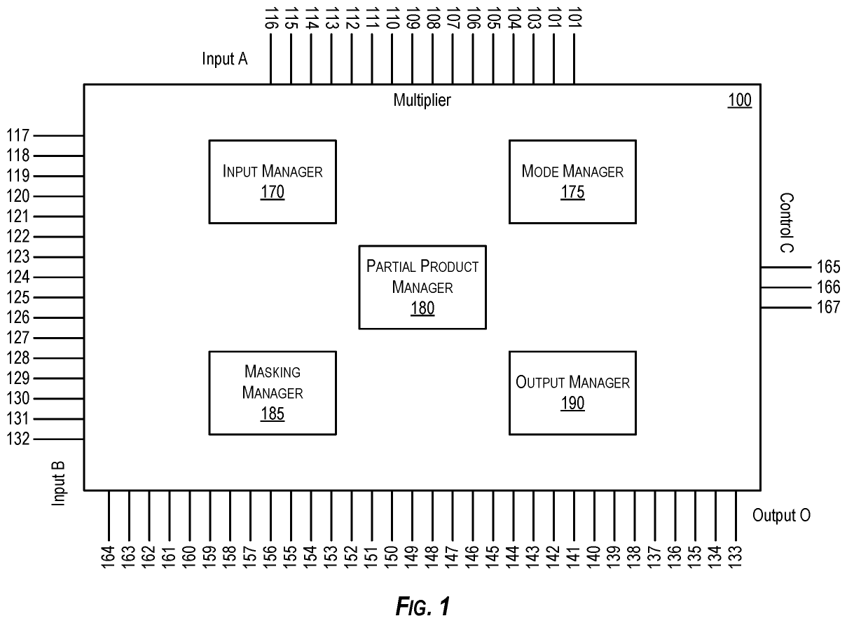

FIG. 1 illustrates a masking-based digital binary multiplier 100 according to some embodiments. In some embodiments, multiplier 100 may be implemented as a set of circuits. As shown, multiplier 100 includes a first set of input bits 101-116, a second set of input bits 117-132, a set of output bits 133-164, and a set of control bits 165-167. Thus, for this example, multiplier 100 is configured to receive two 16-bit inputs, receive a 3-bit control signal, and provide a 32-bit output. FIG. 1 also shows that multiplier 100 includes input manager 170, mode manager 175, partial product manager 180, masking manager 185, and output manager 190. In some embodiments, each one of input manager 170, mode manager 175, partial product manager 180, masking manager 185, and output manager 190 can be implemented as a circuit.

Input manager 170 is configured to manage the inputs received from the first set of input bits 101-116 and the second set of input bits 117-132. Upon receiving values for input bits 101-132, input manager 170 may send them to partial product manager 180 for further processing.

Mode manager 175 is responsible for managing the mode of operation of multiplier 100. For example, mode manager 175 can receive a control signal from the set of control bits 165-167. Based on the values of control bits 165-167, mode manager 175 determines a mode of operation for multiplier 100. Then, mode manager 175 sends the determined mode of operation to masking manager 185.

Partial product manager 180 handles the generation of partial products for multiplier 100. For instance, when partial product manager 180 receives values for the first set of input bits 101-116 and values for the second set of input bits 117-132, partial product manager 180 generates partial products based on those values. Specifically, partial product manager 180 performs a logical AND operation between each bit in the first set of input bits 101-116 with each bit in the second set of input bits 117-132. The result of each logical AND operation is a partial product.

Masking manager 185 is configured to mask certain partial products based on the mode of operation of multiplier 100. For example, when masking manager 185 receives the mode of operation from mode manager 175, masking manager 185 determines a subset of the partial products to mask. In some embodiments, masking manager 185 masks a partial product by setting the result of the logical AND operation to zero. In other embodiments, masking manager 185 masks a partial product by setting the inputs to the logical AND operation to zero.

Output manager 190 is responsible for generating the values for the set of output bits 133-164. For instance, output manager 190 can generate the value for a particular bit in the set of output bits 133-164 by summing the partial products associated with the particular bit, including the partial products that have been masked. The values that output manager 190 generates for the set of output bits 133-164 is the product between the values for the first set of input bits 101-116 and the values for the second set of input bits 117-132.

FIG. 1 illustrates a digital binary multiplier with a specific number of bits for Input A, Input B, Output O, and Control C. This is merely one example of a masking-based digital binary multiplier. One of ordinary skill in the art will understand that the techniques described in the present application can be implemented for a masking-based digital binary multiplier that has different numbers of bits for Input A, Input B, Output O, and Control C.

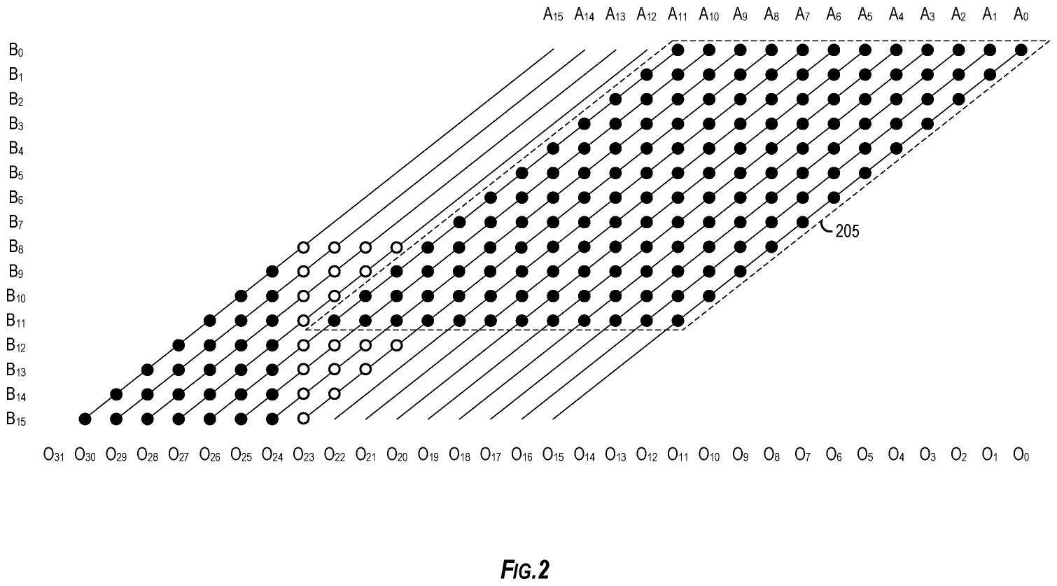

Several example modes of operation of multiplier 100 will now be described by reference to FIGS. 2-5. For these examples, inputs A₀-A₁₅ correspond to the first set of input bits 101-116, respectively; inputs B₀-B₁₅ correspond to the second set of input bits 117-132, respectively; and outputs O₀-O₃₁ correspond to the set of output bits 133-164, respectively.

FIG. 2 illustrates a first mode of operation for masking-based digital binary multiplier 100 according to some embodiments. For this example, based on the control signal that mode manager 175 receives from the set of control bits 165-167, mode manager 175 determines that multiplier is to operate in the first mode of operation. In this first mode of operation, multiplier 100 is configured to multiply a pair of 12-bit input values together to produce one 24-bit output value. Each dot shown in FIG. 2 represents a partial product between a bit from input A and a bit from input B. The diagonal lines indicate which bit from input A is used for the partial product. The row on which a dot is positioned indicates the corresponding bit from input B that is used for the partial product. For example, the top right most dot represents a partial product between A₀ and B₀. The top left most dot represents a partial product between A₁₁ and B₀. The right most dot in the second row from the top represents a partial product between A₀ and B₁. The left most dot in the second row from the top represents a partial product between A₁₁ and B₁.

For this example, the first twelve bits of input A (i.e., A₀-A₁₁) are multiplied with the first twelve bits of input B (i.e., B₀-B₁₁). The partial products generated by partial product manager 180 that are relevant to determine the product between the first twelve bits of input A and the first twelve bits of input B are the dots encompassed in the dashed box 205. To prevent irrelevant partial products from being incorrectly taken into account in the determination of the relevant output bits (i.e., output bits O₀-O₂₃ in this example), masking manager 185 masks the partial products represented by white dots when multiplier 100 is operating in this first mode of operation. Since output bits O₂₄-O₃₁ are not relevant in this mode of operation of multiplier 100, masking manager 185 does not mask the partial products in those columns.

Output manager 190 generates values for output bits O₀-O₂₃ by summing the partial products in each of the corresponding columns shown in FIG. 2. For instance, output manager 190 generates the value for output bit O₀ by using the partial product between A₀ and B₀ since that is the only partial product in the same column as output bit O₀. Output manager 190 generates the value for output bit O₁ by adding together the partial product between A₁ and B₀ and the partial product between A₀ and B₁ and using the sum as the value for the output bit O₁. As another example, output manager 190 generates the value for output bit O₂ by adding together the partial product between A₂ and B₀, the partial product between A₁ and B₁, and the partial product between A₀ and B₂. Then, output manager 190 uses the sum as the value for the output bit O₂. In this example, the value represented by output bits O₀-O₂₃ is the product between the value represented by input bits A₀-A₁₁ and the value represented by input bits B₀-B₁₁.

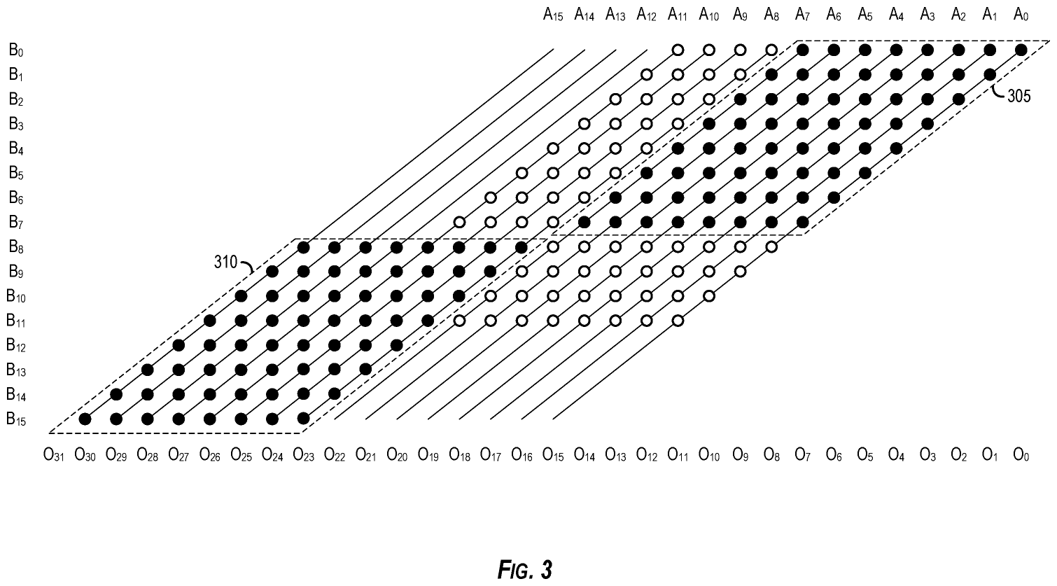

FIG. 3 illustrates a second mode of operation for masking-based digital binary multiplier 100 according to some embodiments. In this example, based on the control signal that mode manager 175 receives from the set of control bits 165-167, mode manager 175 determines that multiplier is to operate in the second mode of operation. For the second mode of operation, multiplier 100 is configured to multiply two pairs of 8-bit input values together to produce two 16-bit output values. Each dot depicted in FIG. 3 represents a partial product between a bit from input A and a bit from input B. Similar to FIG. 2, the diagonal lines indicate which bit from input A is used for the partial product and the row on which a dot is positioned indicates the corresponding bit from input B that is used for the partial product.

In this example, the first eight bits of input A (i.e., A₀-A₇) are multiplied with the first eight bits of input B (i.e., B₀-B₇). The partial products generated by partial product manager 180 that are relevant to determine the product between the first eight bits of input A and the first eight bits of input B are the dots encompassed in the dashed box 305. In addition, the last eight bits of input A (i.e., A₈-A₁₅) are multiplied with the last eight bits of input B (i.e., B₇-B₁₅). The partial products generated by partial product manager 180 that are relevant to determine the product between the last eight bits of input A and the last eight bits of input B are the dots encompassed in the dashed box 310. In order to prevent irrelevant partial products from erroneously influencing the determination of the relevant output bits (i.e., output bits O₀-O₃₁ in this example), masking manager 185 masks the partial products represented by white dots when multiplier 100 is operating in the second mode of operation.

Output manager 190 generates values for output bits O₀-O₃₁ by summing the partial products in each of the corresponding columns depicted in FIG. 3. For example, output manager 190 generates the value for output bit O₀ by using the partial product between A₀ and B₀ as that is the only partial product in the same column as output bit O₀. Output manager 190 generates the value for output bit O₁ by adding together the partial product between A₁ and B₀ and the partial product between A₀ and B₁ and using the sum as the value for the output bit O₁. As another example, output manager 190 generates the value for output bit O₁₈ by adding together the partial product between A₁₁ and B₇, the partial product between A₁₀ and B₈, the partial product between A₉ and B₉, the partial product between A₈ and B₁₀, and the partial product between A₇ and B₁₁. Output manager 190 uses the sum as the value for the output bit O₁₈. For this example, the value represented by output bits O₀-O₁₅ is the product between the value represented by input bits A₀-A₇ and the value represented by input bits B₀-B₇ and the value represented by output bits O₁₆-O₃₁ is the product between the value represented by input bits A₉-A₁₅ and the value represented by input bits B₉-B₁₅.

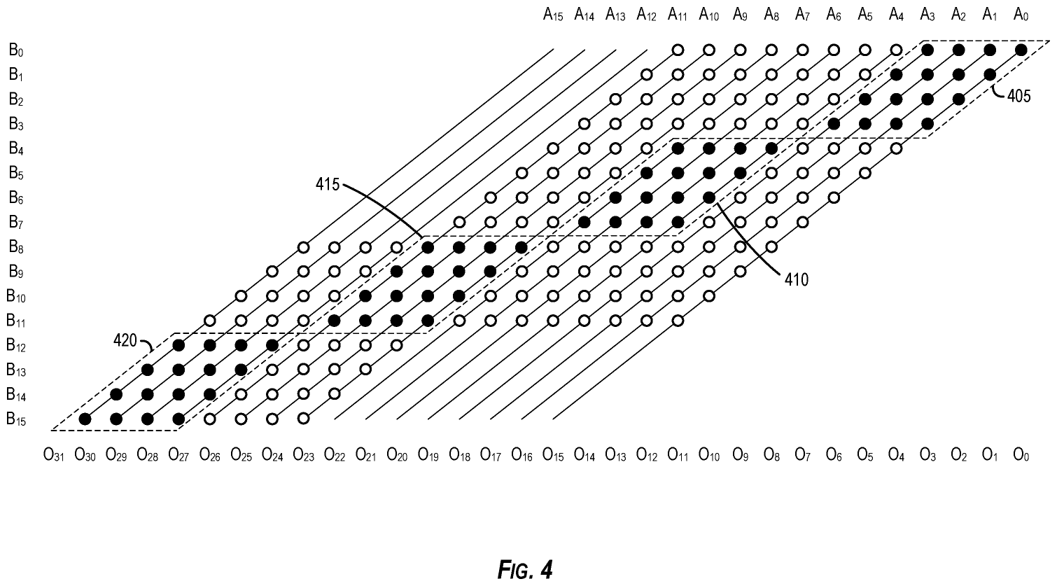

FIG. 4 illustrates a third mode of operation for the masking-based digital binary multiplier illustrated in FIG. 1 according to some embodiments. For this example, based on the control signal that mode manager 175 receives from the set of control bits 165-167, mode manager 175 determines that multiplier is to operate in the third mode of operation. In the third mode of operation, multiplier 100 is configured to multiply four pairs of 4-bit input values together to produce four 8-bit output values. Each dot shown in FIG. 4 represents a partial product between a bit from input A and a bit from input B. Similar to FIGS. 2 and 3, the diagonal lines indicate which bit from input A is used for the partial product and the row on which a dot is positioned indicates the corresponding bit from input B that is used for the partial product.

Here, the first set of four bits of input A (i.e., A₀-A₃) is multiplied with the first set of four bits of input B (i.e., B₀-B₃). The partial products generated by partial product manager 180 that are relevant to determine the product between the first set of four bits of input A and the first set of four bits of input B are the dots encompassed in the dashed box 405. Also, the second set of four bits of input A (i.e., A₄-A₇) is multiplied with the second set of four bits of input B (i.e., B₄-B₇). The partial products generated by partial product manager 180 that are relevant to determine the product between the second set of four bits of input A and the second set of four bits of input B are the dots encompassed in the dashed box 410. The third set of four bits of input A (i.e., A₈-A₁₁) is multiplied with the third set of four bits of input B (i.e., B₈-B₁₁). The partial products generated by partial product manager 180 that are relevant to determine the product between the third set of four bits of input A and the third set of four bits of input B are the dots encompassed in the dashed box 415. Lastly, the fourth set of four bits of input A (i.e., A₁₂-A₁₅) is multiplied with the fourth set of four bits of input B (i.e., B₁₂-B₁₅). The partial products generated by partial product manager 180 that are relevant to determine the product between the fourth set of four bits of input A and the fourth set of four bits of input B are the dots encompassed in the dashed box 420. To prevent irrelevant partial products from being incorrectly taken into consideration in the determination of the relevant output bits (i.e., output bits O₀-O₃₁ in this example), masking manager 185 masks the partial products represented by white dots when multiplier 100 is operating in this third mode of operation.

Output manager 190 generates values for output bits O₀-O₃₁ by summing the partial products in each of the corresponding columns illustrated in FIG. 4. For instance, output manager 190 generates output bit O₁ by adding together the partial product between A₁ and B₀ and the partial product between A₀ and B₁ and using the sum as the value for the output bit O₁. As another example, output manager 190 generates the value for output bit O₁₂ by adding together the partial product between A₁₁ and B₁, the partial product between A₁₀ and B₂, the partial product between A₉ and B₃, the partial product between A₈ and B₄, the partial product between A₇ and B₅, the partial product between A₆ and B₆, the partial product between A₅ and B₇, the partial product between A₄ and B₈, the partial product between A₃ and B₉, the partial product between A₂ and B₁₀, and the partial product between A₁ and B₁₁. Next, output manager 190 uses the sum as the value for the output bit O₁₂. In this example, the value represented by output bits O₀-O₇ is the product between the value represented by input bits A₀-A₃ and the value represented by input bits B₀-B₃; the value represented by output bits O₈-O₁₅ is the product between the value represented by input bits A₄-A₇ and the value represented by input bits B₄-B₇; the value represented by output bits O₁₆-O₂₃ is the product between the value represented by input bits A₈-A₁₁ and the value represented by input bits B₈-B₃; and the value represented by output bits O₂₄-O₃₁ is the product between the value represented by input bits A₁₂-A₁₅ and the value represented by input bits B₁₂-B₁₅.

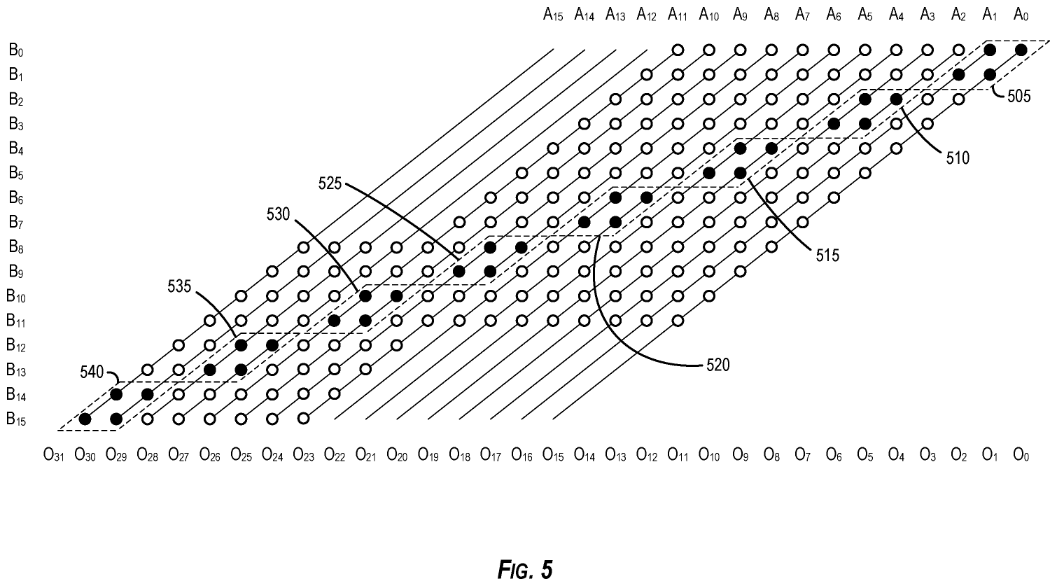

FIG. 5 illustrates a fourth mode of operation for the masking-based digital binary multiplier illustrated in FIG. 1 according to some embodiments. In this example, based on the control signal that mode manager 175 receives from the set of control bits 165-167, mode manager 175 determines that multiplier is to operate in the fourth mode of operation. For the fourth mode of operation, multiplier 100 is configured to multiply eight pairs of 2-bit input values together to produce eight 2-bit output values. Each dot illustrated in FIG. 5 represents a partial product between a bit from input A and a bit from input B. Similar to FIGS. 2-4, the diagonal lines indicate which bit from input A is used for the partial product and the row on which a dot is positioned indicates the corresponding bit from input B that is used for the partial product.

For this example, the first set of two bits of input A (i.e., A₀ and A₁) is multiplied with the first set of two bits of input B (i.e., B₀ and B₁). The partial products generated by partial product manager 180 that are relevant to determine the product between the first set of two bits of input A and the first set of two bits of input B are the dots encompassed in the dashed box 505. The second set of two bits of input A (i.e., A₂ and A₃) is multiplied with the second set of two bits of input B (i.e., B₂ and B₃). The partial products generated by partial product manager 180 that are relevant to determine the product between the second set of two bits of input A and the second set of two bits of input B are the dots encompassed in the dashed box 510. Next, the third set of two bits of input A (i.e., A₄ and A₅) is multiplied with the third set of two bits of input B (i.e., B₄ and B₅). The partial products generated by partial product manager 180 that are relevant to determine the product between the third set of two bits of input A and the third set of two bits of input B are the dots encompassed in the dashed box 515. The fourth set of two bits of input A (i.e., A₆ and A₇) is multiplied with the fourth set of two bits of input B (i.e., B₆ and B₇).

The partial products generated by partial product manager 180 that are relevant to determine the product between the fourth set of two bits of input A and the fourth set of two bits of input B are the dots encompassed in the dashed box 520. Then, the fifth set of two bits of input A (i.e., A₈ and A₉) is multiplied with the fifth set of two bits of input B (i.e., B₈ and B₉). The partial products generated by partial product manager 180 that are relevant to determine the product between the fifth set of two bits of input A and the fifth set of two bits of input B are the dots encompassed in the dashed box 525. The sixth set of two bits of input A (i.e., A₁₀ and A₁₁) is multiplied with the sixth set of two bits of input B (i.e., B₁₀ and B₁₁). The partial products generated by partial product manager 180 that are relevant to determine the product between the sixth set of two bits of input A and the sixth set of two bits of input B are the dots encompassed in the dashed box 530. The seventh set of two bits of input A (i.e., A₁₂ and A₁₃) is multiplied with the seventh set of two bits of input B (i.e., B₁₂ and B₁₃). The partial products generated by partial product manager 180 that are relevant to determine the product between the seventh set of two bits of input A and the seventh set of two bits of input B are the dots encompassed in the dashed box 535. Finally, the eighth set of two bits of input A (i.e., A₁₄ and A₁₅) is multiplied with the eighth set of two bits of input B (i.e., B₁₄ and B₁₅). The partial products generated by partial product manager 180 that are relevant to determine the product between the eighth set of two bits of input A and the eighth set of two bits of input B are the dots encompassed in the dashed box 540. In order to prevent irrelevant partial products from erroneously influencing the determination of the relevant output bits (i.e., output bits O₀-O₃₁ in this example), masking manager 185 mask the partial products represented by white dots when multiplier 100 is operating in the fourth mode of operation.

Output manager 190 generates values for output bits O₀-O₃₁ by summing the partial products in each of the corresponding columns shown in FIG. 5. For example, output manager 190 generates the value for output bit O₁ by adding together the partial product between A₁ and B₀ and the partial product between A₀ and B₁ and using the sum as the value for the output bit O₁. As another example, output manager 190 generates the value for output bit O₂₁ by adding together the partial product between A₁₃ and B₈, the partial product between A₁₂ and B₉, the partial product between A₁₁ and B₁₀, the partial product between A₁₀ and B₁₁, the partial product between A₉ and B₁₂, and the partial product between A₈ and B₁₃. Output manager 190 then uses the sum as the value for the output bit O₂₁. For this example, the value represented by output bits O₀-O₃ is the product between the value represented by input bits A₀ and A₁ and the value represented by input bits B₀ and B₁; the value represented by output bits O₄-O₇ is the product between the value represented by input bits A₂ and A₃ and the value represented by input bits B₂ and B₃; the value represented by output bits O₈-O₁₁ is the product between the value represented by input bits A₄ and A₅ and the value represented by input bits B₄ and B₅; the value represented by output bits O₁₂-O₁₅ is the product between the value represented by input bits A₆ and A₇ and the value represented by input bits B₆ and B₇; the value represented by output bits O₁₆-O₁₉ is the product between the value represented by input bits A₈ and A₉ and the value represented by input bits B₈ and B₉; the value represented by output bits O₂₀-O₂₃ is the product between the value represented by input bits A₁₀ and A₁₁ and the value represented by input bits B₁₀ and B₁₁; the value represented by output bits O₂₄-O₂₇ is the product between the value represented by input bits A₁₂ and A₁₃ and the value represented by input bits B₁₂ and B₁₃; and the value represented by output bits O₂₈-O₃₁ is the product between the value represented by input bits A₁₄ and A₁₅ and the value represented by input bits B₁₄ and B₁₅.

The examples described above by reference to FIGS. 2-5 show how a single digital binary multiplier may operate in multiple different modes. Such a multiplier utilizes a masking approach that allows the multiplier to efficiently perform high precision multiplications at low throughput (e.g., the first mode of operation illustrated in FIG. 2), low precision multiplications at high throughput (e.g., the fourth mode of operation illustrated in FIG. 5), and medium precision multiplications at medium throughput (e.g., the second and third modes of operation illustrated in FIGS. 3 and 4) based on the mode in which the multiplier is operating. In addition, one of ordinary skill in the art will appreciate that different masking-based digital binary multipliers can support different numbers of modes of operation. Furthermore, in addition to summing partial products in a given column together, output manager 190 also sums up any carry bits generated for the given column (e.g., from the summation of partial products and/or carry bits from other columns). Different embodiments may use different techniques for generating carry bits. For example, in some embodiments, a Wallace tree technique can be used. In other embodiments, a Dadda reduction tree technique may be used.

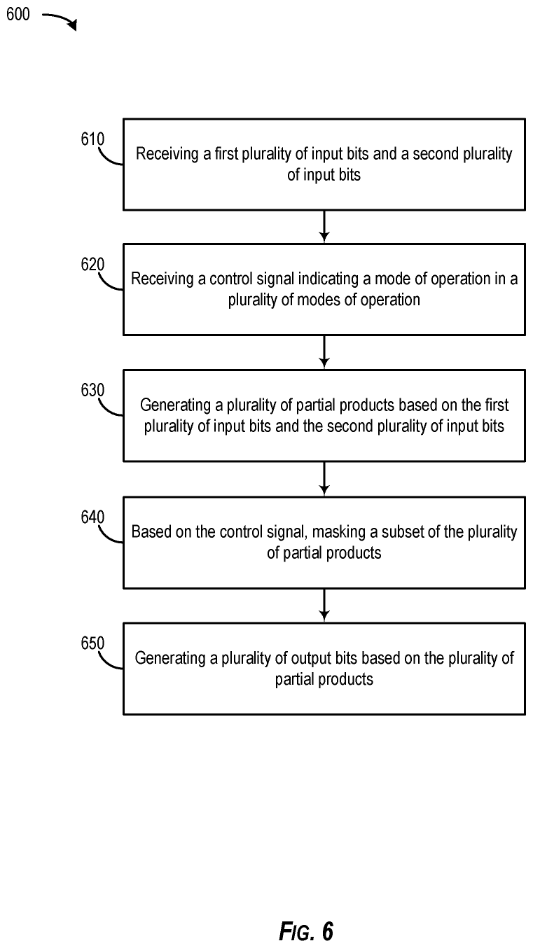

FIG. 6 illustrates a process 600 for performing masking-based bitwise multiplication according to some embodiments. In some embodiments, multiplier 100 performs process 600. Process 600 begins by receiving, at 610, a first plurality of input bits and a second plurality of input bits. Referring to FIG. 1 as an example, input manager 170 may receive the first plurality of input bits from the first set of input bits 101-116 and the second plurality of input bits from the second set of input bits 117-132.

Next, process 600 receives, at 620, a control signal indicating a mode of operation in a plurality of modes of operation. Referring to FIG. 1 as an example, mod manager 175 can receive the control signal indicating mode of operation from the set of control bits 165-167.

Then, process 600 generates, at 630, a plurality of partial products based on the first plurality of input bits and the second plurality of input bits. Referring to FIG. 1 as an example, partial product manager 180 may generate the plurality of partial products based on the first plurality of input bits and the second plurality of input bits. For instance, partial product manager 180 can perform a logical AND operation between each bit in the first set of input bits 101-116 with each bit in the second set of input bits 117-132. The result of each logical AND operation is a partial product.

Based on the control signal, process 600 masks, at 640, a subset of the plurality of partial products. Referring to FIGS. 1 and 3 as an example, masking manager 185 masks the subset of the plurality of partial products based on the control signal. For example, masking manager 185 may mask the partial products represented by white dots in FIG. 3 when multiplier 100 is operating in the second mode of operation.

Finally, process 600 generates, at 650, a plurality of output bits based on the plurality of partial products. Referring to FIGS. 1 and 3 as an example, output manager 190 generates the plurality of output bits. For instance, output manager 190 can generate output bits O₀-O₃₁ by summing the partial products in each of the corresponding columns shown in FIG. 3.

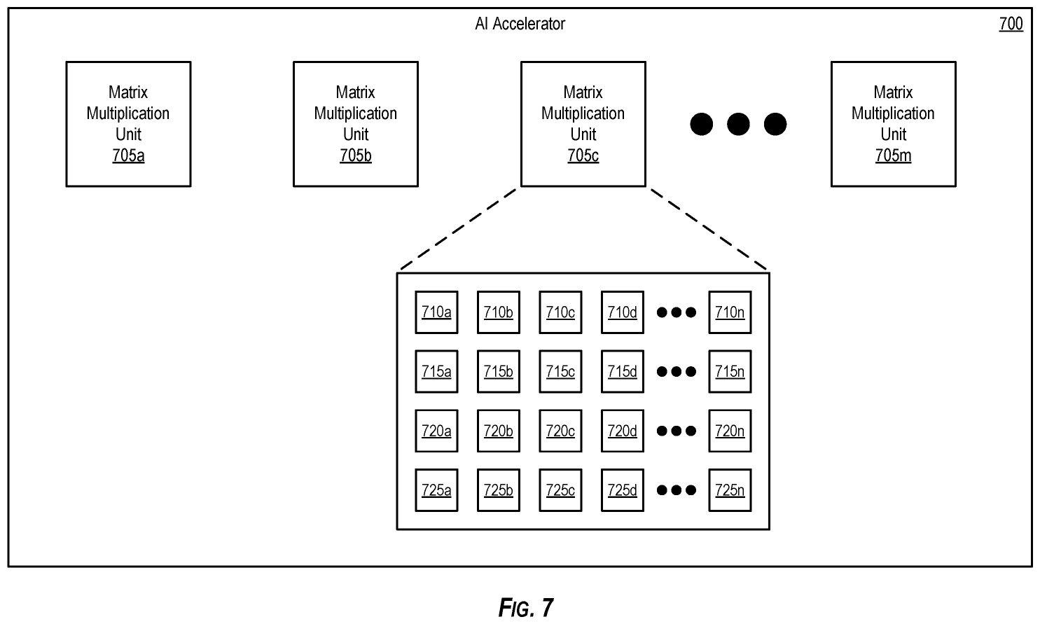

FIG. 7 illustrates an A₁ accelerator 700 according to some embodiments. In some cases, A₁ accelerator 700 may be used for machine learning workloads (e.g., training machine learning models, using machine learning models for inference, etc.). As such, A₁ accelerator 700 can support any number of machine learning data types. For example, A₁ accelerator 700 may support floating point data types as well as shared exponent floating point data types (e.g., floating data types where multiple floating point values are stored together, share a common exponent value, and each has its own separate mantissa value).

As shown, A₁ accelerator 700 includes matrix multiplication units 705a-m. Each of the matrix multiplication units 705a-m is configured to perform multiplication operations on matrices. In some embodiments, dot product units configured to perform dot product operations can be used to implement A₁ accelerator 700 instead of matrix multiplication units 705a-m. In other embodiments, A₁ accelerator 700 includes such dot product units in addition to matrix multiplication units 705a-m.

As depicted in FIG. 7, matrix multiplication unit 705c includes digital binary multipliers 710a-n, 715a-n, 720a-n, and 725a-n. Here, each of the digital binary multipliers 710a-n, 715a-n, 720a-n, and 725a-n is implemented by digital binary multiplier 100. In this example, each of the other matrix multiplication units 705a-m can be implemented in the same or similar manner as matrix multiplication unit 705c.

### Further Example Embodiments

In various embodiments, the present disclosure includes systems, methods, and apparatuses for providing masking-based digital binary multipliers. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in some embodiments, the techniques described herein relate to a method, executable by a digital binary multiplier, the method including: receiving a first plurality of input bits and a second plurality of input bits; receiving a control signal indicating a mode of operation in a plurality of modes of operation; generating a plurality of partial products based on the first plurality of input bits and the second plurality of input bits; based on the control signal, masking a subset of the plurality of partial products; and generating a plurality of output bits based on the plurality of partial products.

In some embodiments, the techniques described herein relate to a method, wherein masking the subset of the plurality of partial products includes setting each partial product in the subset of the plurality of partial products to zero.

In some embodiments, the techniques described herein relate to a method, wherein masking the subset of the plurality of partial products includes setting inputs for each partial product in the subset of the plurality of partial products to zero.

In some embodiments, the techniques described herein relate to a method, wherein generating the plurality of output bits is further based on the masked subset of the plurality partial products.

In some embodiments, the techniques described herein relate to a method, wherein generating each output bit in the plurality of output bits includes summing a different subset of the plurality of partial products.

In some embodiments, the techniques described herein relate to a method, wherein the control signal is a first control signal, wherein the mode of operation is a first mode of operation, wherein the plurality of partial products is a first plurality of partial products, wherein the plurality of output bits is a first plurality of output bits, the method further including: receiving a third plurality of input bits and a fourth plurality of input bits; receiving a second control signal indicating a second mode of operation in the plurality of modes of operation; generating a second plurality of partial products based on the third plurality of input bits and the fourth plurality of input bits; based on the second control signal, masking a subset of the second plurality of partial products; and generating a second plurality of output bits based on the second plurality of partial products.

In some embodiments, the techniques described herein relate to a method, wherein the first plurality of input bits includes a first set of input bits representing a first numerical value and a second set of input bits representing a second numerical value, wherein the second plurality of inputs bits includes a third set of input bits representing a third numerical value and a fourth set of input bits representing a fourth numerical value.

In some embodiments, the techniques described herein relate to a method, wherein the plurality of output bits includes a first set of output bits representing a fifth numerical value and a second set of output bits representing a sixth numerical value, wherein the fifth numerical value is the product of the first numerical value and the third numerical value, wherein the sixth numerical value is the product of the second numerical value and the fourth numerical value.

In some embodiments, the techniques described herein relate to a method, wherein generating the plurality of partial products includes performing logical AND operations between the first plurality of input bits and the second plurality of input bits.

In some embodiments, the techniques described herein relate to a method, wherein the digital binary multiplier is included in an artificial intelligence (AI) accelerator.

In some embodiments, the techniques described herein relate to a digital binary multiplier circuit including: a first circuit configured to receive a first plurality of input bits and a second plurality of input bits; a second circuit configured to receive a control signal indicating a mode of operation in a plurality of modes of operation; a third circuit configured to generate a plurality of partial products based on the first plurality of input bits and the second plurality of input bits; a fourth circuit configured to mask, based on the control signal, a subset of the plurality of partial products; and a fifth circuit configured to generate a plurality of output bits based on the plurality of partial products.

In some embodiments, the techniques described herein relate to a digital binary multiplier circuit, wherein masking the subset of the plurality of partial products includes setting each partial product in the subset of the plurality of partial products to zero.

In some embodiments, the techniques described herein relate to a digital binary multiplier circuit, wherein masking the subset of the plurality of partial products includes setting inputs for each partial product in the subset of the plurality of partial products to zero.

In some embodiments, the techniques described herein relate to a digital binary multiplier circuit, wherein generating the plurality of output bits is further based on the masked subset of the plurality partial products.

In some embodiments, the techniques described herein relate to a digital binary multiplier circuit, wherein generating each output bit in the plurality of output bits includes summing a different subset of the plurality of partial products.

In some embodiments, the techniques described herein relate to a digital binary multiplier circuit, wherein the control signal is a first control signal, wherein the mode of operation is a first mode of operation, wherein the plurality of partial products is a first plurality of partial products, wherein the plurality of output bits is a first plurality of output bits, wherein the first circuit is further configured to receive a third plurality of input bits and a fourth plurality of input bits, wherein the second circuit is further configured to receive a second control signal indicating a second mode of operation in the plurality of modes of operation, wherein the third circuit is further configured to generate a second plurality of partial products based on the third plurality of input bits and the fourth plurality of input bits, wherein the fourth circuit is further configured to mask, based on the second control signal, a subset of the second plurality of partial products, and wherein the fifth circuit is further configured to generate a second plurality of output bits based on the second plurality of partial products.

In some embodiments, the techniques described herein relate to a digital binary multiplier circuit, wherein the first plurality of input bits includes a first set of input bits representing a first numerical value and a second set of input bits representing a second numerical value, wherein the second plurality of inputs bits includes a third set of input bits representing a third numerical value and a fourth set of input bits representing a fourth numerical value.

In some embodiments, the techniques described herein relate to a digital binary multiplier circuit, wherein the plurality of output bits includes a first set of output bits representing a fifth numerical value and a second set of output bits representing a sixth numerical value, wherein the fifth numerical value is the product of the first numerical value and the third numerical value, wherein the sixth numerical value is the product of the second numerical value and the fourth numerical value.

In some embodiments, the techniques described herein relate to a digital binary multiplier circuit, wherein generating the plurality of partial products includes performing logical AND operations between the first plurality of input bits and the second plurality of input bits.

In some embodiments, the techniques described herein relate to a digital binary multiplier circuit, wherein the digital binary multiplier circuit is included in an artificial intelligence (AI) accelerator.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

In some embodiments, the techniques described herein relate to a digital binary multiplier circuit, wherein generating the plurality of partial products includes performing logical AND operations between the first plurality of input bits and the second plurality of input bits.

In some embodiments, the techniques described herein relate to a digital binary multiplier circuit, wherein the digital binary multiplier circuit is included in an artificial intelligence (AI) accelerator.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method, executable by a digital binary multiplier, the method comprising:
receiving a first plurality of input bits and a second plurality of input bits;
receiving a control signal indicating a mode of operation in a plurality of modes of operation;
generating a plurality of partial products based on the first plurality of input bits and the second plurality of input bits;
based on the control signal, masking a subset of the plurality of partial products; and
generating a plurality of output bits based on the plurality of partial products.

2. The method of claim 1, wherein masking the subset of the plurality of partial products comprises setting each partial product in the subset of the plurality of partial products to zero.

3. The method of claim 1, wherein masking the subset of the plurality of partial products comprises setting inputs for each partial product in the subset of the plurality of partial products to zero.

4. The method of claim 1, wherein generating the plurality of output bits is further based on the masked subset of the plurality partial products.

5. The method of claim 1, wherein generating each output bit in the plurality of output bits comprises summing a different subset of the plurality of partial products.

6. The method of claim 1, wherein the control signal is a first control signal, wherein the mode of operation is a first mode of operation, wherein the plurality of partial products is a first plurality of partial products, wherein the plurality of output bits is a first plurality of output bits, the method further comprising:
receiving a third plurality of input bits and a fourth plurality of input bits;
receiving a second control signal indicating a second mode of operation in the plurality of modes of operation;
generating a second plurality of partial products based on the third plurality of input bits and the fourth plurality of input bits;
based on the second control signal, masking a subset of the second plurality of partial products; and
generating a second plurality of output bits based on the second plurality of partial products.

7. The method of claim 1, wherein the first plurality of input bits comprises a first set of input bits representing a first numerical value and a second set of input bits representing a second numerical value, wherein the second plurality of inputs bits comprises a third set of input bits representing a third numerical value and a fourth set of input bits representing a fourth numerical value.

8. The method of claim 7, wherein the plurality of output bits comprises a first set of output bits representing a fifth numerical value and a second set of output bits representing a sixth numerical value, wherein the fifth numerical value is the product of the first numerical value and the third numerical value, wherein the sixth numerical value is the product of the second numerical value and the fourth numerical value.

9. The method of claim 1, wherein generating the plurality of partial products comprises performing logical AND operations between the first plurality of input bits and the second plurality of input bits.

10. The method of claim 1, wherein the digital binary multiplier is included in an artificial intelligence (AI) accelerator.

11. A digital binary multiplier circuit comprising:
a first circuit configured to receive a first plurality of input bits and a second plurality of input bits;
a second circuit configured to receive a control signal indicating a mode of operation in a plurality of modes of operation;
a third circuit configured to generate a plurality of partial products based on the first plurality of input bits and the second plurality of input bits;
a fourth circuit configured to mask, based on the control signal, a subset of the plurality of partial products; and
a fifth circuit configured to generate a plurality of output bits based on the plurality of partial products.

12. The digital binary multiplier circuit of claim 11, wherein masking the subset of the plurality of partial products comprises setting each partial product in the subset of the plurality of partial products to zero.

13. The digital binary multiplier circuit of claim 11, wherein masking the subset of the plurality of partial products comprises setting inputs for each partial product in the subset of the plurality of partial products to zero.

14. The digital binary multiplier circuit of claim 11, wherein generating the plurality of output bits is further based on the masked subset of the plurality partial products.

15. The digital binary multiplier circuit of claim 11, wherein generating each output bit in the plurality of output bits comprises summing a different subset of the plurality of partial products.

16. The digital binary multiplier circuit of claim 11, wherein the control signal is a first control signal, wherein the mode of operation is a first mode of operation, wherein the plurality of partial products is a first plurality of partial products, wherein the plurality of output bits is a first plurality of output bits,
wherein the first circuit is further configured to receive a third plurality of input bits and a fourth plurality of input bits,
wherein the second circuit is further configured to receive a second control signal indicating a second mode of operation in the plurality of modes of operation,
wherein the third circuit is further configured to generate a second plurality of partial products based on the third plurality of input bits and the fourth plurality of input bits,
wherein the fourth circuit is further configured to mask, based on the second control signal, a subset of the second plurality of partial products, and
wherein the fifth circuit is further configured to generate a second plurality of output bits based on the second plurality of partial products.

17. The digital binary multiplier circuit of claim 11, wherein the first plurality of input bits comprises a first set of input bits representing a first numerical value and a second set of input bits representing a second numerical value, wherein the second plurality of inputs bits comprises a third set of input bits representing a third numerical value and a fourth set of input bits representing a fourth numerical value.

18. The digital binary multiplier circuit of claim 17, wherein the plurality of output bits comprises a first set of output bits representing a fifth numerical value and a second set of output bits representing a sixth numerical value, wherein the fifth numerical value is the product of the first numerical value and the third numerical value, wherein the sixth numerical value is the product of the second numerical value and the fourth numerical value.

19. The digital binary multiplier circuit of claim 11, wherein generating the plurality of partial products comprises performing logical AND operations between the first plurality of input bits and the second plurality of input bits.

20. The digital binary multiplier circuit of claim 11, wherein the digital binary multiplier circuit is included in an artificial intelligence (AI) accelerator.
